(19) United States
(12) Patent Application Publication
(10) Pub. No.: US 2005/0220304 A1
(43) Pub. Date: Oct. 6, 2005

(54) Method for authentication between devices

(75) Inventors: Petrus Johannes Lenoir, Eindhoven (NL); Johan Cornelis Talstra, Eindhoven (NL); Sebastiaan Antonius Fransiscus Arnoldus Van Den Heuvel, Eindhoven (NL); Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/517,924

(22) PCT Filed: May 27, 2003
(86) PCT No.: PCT/IB03/02340

§ 371 Date: Dec. 14, 2004

(30) Foreign Application Priority Data
Jun. 17, 2002 (EP) 02077423.8

(51) Int. Cl. G06F 11/30; G06F 12/14

(52) U.S. Cl. 380/255

(57) ABSTRACT

A certifying authority provides a method for whitelist-based controlling of authentication of a first device (102) in a system (100) to a second device (103). The method comprises issuing to the first device (102) a group certificate identifying a range of non-revoked device identifiers, said range encompassing the device identifier of the first device (102). Preferably the device identifiers correspond to leaf nodes in a hierarchically ordered tree, and the group certificate identifies a node (202-207) in the tree representing a subtree in which the leaf nodes correspond to said range. The group certificate can also identify a further node (308, 310, 312) in the subtree which represents a sub-subtree in which the leaf nodes correspond to revoked device identifiers. Alternatively, the device identifiers are selected from a sequentially ordered range, and the group certificate identifies a subrange of the sequentially ordered range, said subrange encompassing the whitelisted device identifiers.

The invention relates to a method of controlling authentication of a first device to a second device, the devices being assigned respective device identifiers.

### BACKGROUND OF THE INVENTION

In recent years, the amount of content protection systems has grown at a rapid pace. Some of these systems only protect the content against illegal copying while others are also prohibiting the user to get access to the content. The first category is called Copy Protection (CP) systems and has been traditionally the main focus for Consumer Electronics (CE) devices, as this type of content protection is thought to be implementable in an inexpensive way and does not need bi-directional interaction with the content provider. Examples are CSS (Content Scrambling System), the protection system of DVD ROM discs and DTCP (Digital Transmission Content Protection), the protection system for IEEE 1394 connections. The second category is known under several names. In the broadcast world they are generally known as CA (Conditional Access) systems, while in the Internet world they are generally known as DRM (Digital Rights Management) systems.

Recently new content protection systems have been introduced (like SmartRight from Thomson, or DTCP from DTLA) in which a set of devices can authenticate each other through a bi-directional connection. Based on this authentication, the devices will trust each other and this will enable them to exchange protected content. In the licenses accompanying the content, it is described which rights the user has and what operations he/she is allowed to perform on the content.

The trust, which is necessary for intercommunication between devices, is based on some secret, only known to devices that were tested and certified to have secure implementations. Knowledge of the secret is tested using an authentication protocol. The best solutions for these protocols are those which employ ‘public key’ cryptography, which use a pair of two different keys. The secret to be tested is then the secret key of the pair, while the public key can be used to verify the results of the test. To ensure the correctness of the public key and to check whether the key-pair is a legitimate pair of a certified device, the public key is accompanied by a certificate, that is digitally signed by the Certification Authority, the organization which manages the distribution of public/private key-pairs for all devices. In a simple implementation the public key of the Certification Authority is hard-coded into the implementation of the device.

A certificate is a bit-string, which contains an M-bit message-part and a C-bit signature-part appended to it. C is usually in the range of 512 . . . 2048 bits and typically 1024 bits. For M<C, the signature is computed based on the message itself, for M>C it is computed based on a summary of the message. Below, the first case: M<C, is the more relevant one. The signature depends sensitively on the contents of the message, and has the property that it can be constructed only by the Certification Authority, but verified by everybody. Verification in this context means: checking that the signature is consistent with the message. If somebody has changed but a single bit of the message, the signature will no longer be consistent.

In typical security scenarios, there are several different devices involved, which might not all be implemented with equal levels of tamper-proofing. Such a system should therefore be resistant to the hacking of individual devices, which might enable illegal storing, copying and/or redistribution of digital content. An important technique to increase the resistance is the so-called revocation of these hacked devices.

Revocation means the withdrawal of the trust in that device. The effect of revocation is that other devices in the network do not want to communicate anymore with the revoked device. Revocation can be achieved in several different manners. Two different techniques would be to use so-called black lists (a list of revoked devices) or white lists (a list of un-revoked devices).

In the black list scenario, the device that is to verify the trust of its communication partner, needs to have an up-to-date version of the list and checks whether the ID of the other device is on that list. The advantage of black lists is that the devices are trusted by default and the trust in them is only revoked, if their ID is listed on the revocation list. This list will be initially very small, but it can potentially grow unrestrictedly. Therefore both the distribution to and the storage on CE devices of these revocation lists might be problematic in the long run.

In the white list scenario, a device has to prove to others that it is still on the list of allowed communication partners. It will do this by presenting an up-to-date version of a certificate, which states that the device is on the white list. The white list techniques overcomes the storage problem, by having only a fixed length certificate stored in each device which proves that that device is on the white list. The revocation acts by sending all devices, except for the revoked ones, a new version of the white list certificate. Although now the storage in the devices is limited, the distribution of the white list certificates is an almost insurmountable problem if no efficient scheme is available.

### SUMMARY OF THE INVENTION

It is one object of the invention to provide a system according to the preamble, which enables efficient distribution and storage of white list certificates.

This object is achieved according to the invention in a method comprising distributing to the first device a group certificate identifying a range of non-revoked device identifiers, said range encompassing the device identifier of the first device.

The invention provides a technique which combines the advantages of black lists (initially small distribution lists) with the main advantage of white lists (limited storage). Preferably, this technique additionally uses a device certificate, which proves the ID of a device. This device certificate is already present in the devices (independent of revocation) as the basis for the initial trust and is installed, e.g., during production in the factory.

Every device now only needs to store a single group certificate, i.e. the group certificate that identifies a range encompassing its own device identifier. This means that the storage requirements for certificates are fixed and can be computed in advance. It is now possible to optimize the implementation of these devices, for example by installing a memory that is exactly the right size, rather than a “sufficiently large” memory as would be necessary in the prior art.

As to distribution, it is now no longer necessary to always send out separate certificates for every single device in the system. By choosing an appropriate grouping of device identifiers, a single group certificate suffices for all the devices in the group. The method thus is more efficient.

The first device can now authenticate itself by presenting the group certificate to the second device. Of course the authentication of the first device to the second device may comprise other steps in addition to the presenting of the group certificate. For instance, the first device could also establish a secure authenticated channel with the second device, present a certificate containing its device identifier to the second device, and so on. Authentication is succesful if the second device determines that the device identifier of the first device is actually contained in the range given in the group certificate. The authentication can be made mutual by simply also having the second device present its own group certificate to the first device.

In an embodiment the respective device identifiers correspond to leaf nodes in a hierarchically ordered tree, and the group certificate identifies a node in the hierarchically ordered tree, said node representing a subtree in which the leaf nodes correspond to the range of non-revoked device identifiers. This has the advantage that using a hierarchy makes it possible to very efficiently identify a group. A very large group of devices can be identified with a single identifier corresponding to a node high in the hierarchy.

In an improvement of this embodiment the group certificate further identifies a further node in the subtree, said further node representing a further subtree in which the leaf nodes correspond to device identifiers excluded from the range of non-revoked device identifiers. In the previous approach, if a device in the subtree is revoked, a number of new certificates needs to be issued for the remaining non-revoked subtrees. The present improvement has the advantage that when a small number of devices in a subtree is revoked, it is not immediately necessary to issue new certificates for a lot of new subtrees.

As an enhancement, another group certificate can be issued that identifies a yet further subtree, part of the further subtree. This way, this part of the subtree can be maintained in the range of non-revoked device identifiers.

It may be desirable to agree in advance to always revoke one device ID in the group, for example the device ID zero. This way, even if no actual devices are revoked, the group certificate is always consistently formed.

In a further embodiment the respective device identifiers are selected from a sequentially ordered range, and the group certificate identifies a subrange of the sequentially ordered range, said subrange encompassing the range of non-revoked device identifiers. This advantageously combines the small transmission size of the simple black listing method discussed above with the small storage size of the white listing methods. If now a sorted list of all revoked devices (e.g., in ascending order) is created, then the authorized groups consist of the devices between any two elements of this list. Now the transmission size is at most equal to the size in the simple black listing case (of course, the data that is transmitted is identical to the black list, but the interpretation is different).

In a further embodiment a single group certificate identifies plural respective ranges of non-revoked device identifiers. This way, a gateway device can easily tell, without verifying many digital signatures at great computational cost, whether a particular group certificate could be relevant to particular devices. It can then filter out those group certificates that are not relevant at all, or verify any digital signatures on those group certificates that are relevant.

In a variant of this embodiment the plural respective ranges in the single group certificate are sequentially ordered, and the single group certificate identifies the plural respective ranges through an indication of the lowest and highest respective ranges in the sequential ordering. This allows the filter to decide whether this certificate might be relevant. This can then be verified by the destination device itself inspecting the signature. It allows the rapid rejection of the bulk of certificates that are irrelevant.

In a further embodiment the group certificate comprises an indication of a validity period and the second device authenticates the first device if said validity period is acceptable. “Acceptable” could mean simply “the current day and time fall within the indicated period”, but preferably also some extensions to the indicated period should be acceptable. This way, delays in propagating new group certificates do not automatically cause a device to fail authentication.

In a further embodiment the group certificate comprises a version indication. This makes it possible for the second device to distribute protected content comprising an indication of a lowest acceptable certificate version to the first device upon successful authentication of the first device, and to successfully authenticate the first device if the version indication in the group certificate is at least equal to the indication of the lowest acceptable certificate version.

Although devices could require from their communication partners a version that is at least as new as the one they are using themselves, this might provide problems as devices that are on the list that are revoked are completely locked out of any exchange of content. They are even locked out from old content, which they were allowed to play before the new revocation list was distributed. In this embodiment these problems are avoided. Even if later the first device is revoked, it is still able to access old content using its old group certificate.

A “version” could be identified numerically, e.g. “version 3.1” or be coupled to a certain point in time, e.g. “the January 2002 version”. The latter has the advantage that it is easier to explain to humans that a particular version is no longer acceptable because it is too old, which can be easily seen by comparing the point in time against the current time. With a purely numerical version number this is much more difficult.

### BRIEF DESCRIPTION OF THE FIGURES

The invention is described below in further detail, by way of example and with reference to the accompanying drawing, wherein:

FIG. 1 schematically shows a system 100 comprising devices 101-105 interconnected via a network;

FIG. 2 is a diagram illustrating a binary tree construction for the Complete Subtree Method;

FIG. 3 is a diagram illustrating a binary tree construction for the Subset Difference Method;

FIG. 4 is a diagram illustrating the Modified Black-Listing Method; and

FIG. 5 is a table illustrating optimization schemes for generating certificates.

### DETAILED DESCRIPTION OF THE PREFERRED EMBODIMENTS

Throughout the figures, same reference numerals indicate similar or corresponding features. Some of the features indicated in the drawings are typically implemented in software, and as such represent software entities, such as software modules or objects.

System Architecture

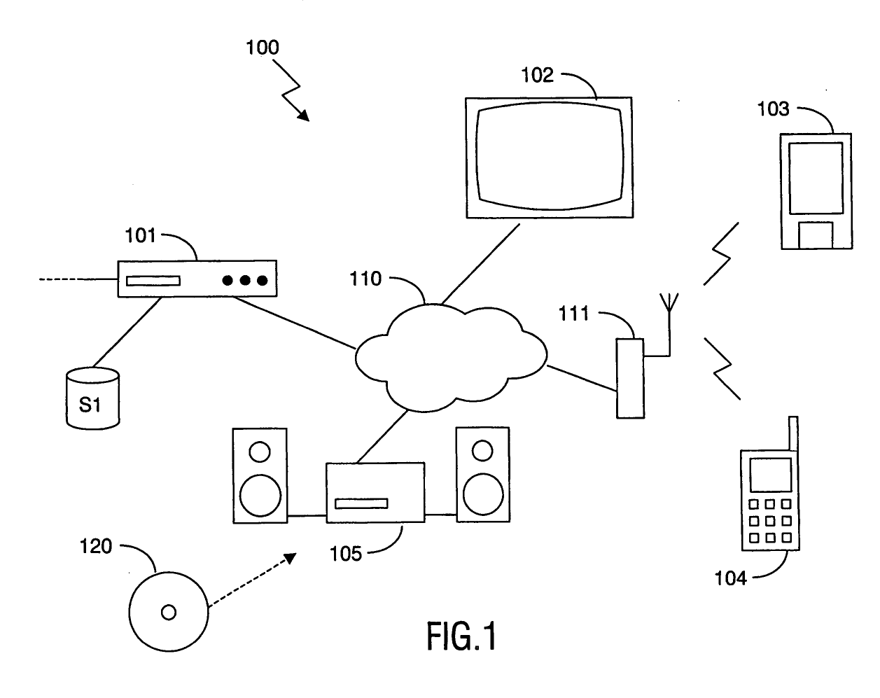

FIG. 1 schematically shows a system 100 comprising devices 101-105 interconnected via a network 110. In this embodiment, the system 100 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures and the likes, is received through a residential gateway or set top box 101. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage S1 could be a Personal Digital Recorder (PDR) of some kind, for example a DVD+RW recorder, to which the set top box 101 is connected. Content can also be provided to the system 100 stored on a carrier 120 such as a Compact Disc (CD) or Digital Versatile Disc (DVD).

The portable display device 103 and the mobile phone 104 are connected wirelessly to the network 110 using a base station 111; for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is often important to ensure that the devices 101-105 in the home network do not make unauthorized copies of the content. To do this, a security framework, typically referred to as a Digital Rights Management (DRM) system is necessary.

In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in European patent application 01204668.6 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking to unauthorized devices and data originating from untrusted devices from entering the system.

It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or their devices are provided with a certificate issued by a Trusted Third Party.

Device Revocation

In general, revocation of a device is the reduction or complete disablement of one or more of its functions if secret information (e.g., identifiers or decryption keys) inside the device have been breached, or discovered through hacking. For example, revocation of a CE device may place limits on the types of digital content that the device is able to decrypt and use. Alternatively, revocation may cause a piece of CE equipment to no longer perform certain functions, such as making copies, on any digital content it receives.

The usual effect of revocation is that other devices in the network 110 do not want to communicate anymore with the revoked device. Revocation can be achieved in several different manners. Two different techniques would be to use so-called black lists (a list of revoked devices) or white lists (a list of un-revoked devices).

Multiple versions of a revocation list may exist. Several mechanisms can be used for the enforcement of the newest version. For instance, devices could require from their communication partners a version that is at least as new as the one they are using themselves. However, this might provide problems as devices that are on the list that are revoked are completely locked out of any exchange of content. They are even locked out from old content, which they were allowed to play before the new revocation list was distributed.

Another version control mechanism is to link the distributed content to a certain version of the revocation list, i.e., the current version number of the revocation list is part of the license accompanying the content. Devices should then only distribute the content if all their communication partners have a version that is at least as new as the version required by the content. The version numbering could be implemented, e.g., by using monotonically increasing numbers.

There are multiple cost factors which determine the attractiveness (and therefore likelihood of application) of a revocation mechanism. One factor is transmission size: every non-revoked device must receive a signed message attesting to the fact that it is still participating in the current version of the revocation system. Another factor is storage size: every non-revoked device must store the certificate that proves that it is still participating in the current version of the revocation system. These two factors seem contradictory. For a small transmission size the authority would best broadcast one signed message containing the identity of all the revoked devices, but this would result in prohibitive storage requirements in the case of 100,000 or so revoked devices. In order to minimize storage size, the certification authority would best transmit an individual certificate to each non-revoked device, containing the Device ID (e.g. serial number, Ethernet-address etc.) of that device; however this causes perhaps billions of messages to be broadcast. Of course in case of a bi-directional link (e.g., Set Top boxes with a phone hook-up), one may just download the certificates relevant to the devices in the AD.

It is one of the purposes of this invention to provide a meaningful compromise between the two extremes represented by the black-list approach and the white-list approach as mentioned earlier. The invention is based in part on the hierarchical key-distribution schemes known from cryptography. In an embodiment of the invention, the certification authority transmits signed messages, which confirm that certain groups of devices are not revoked: one signed message for every non-revoked group. In general the number of groups is much smaller than the number of devices so this requires limited transmission size. Further, the devices store only the message concerning the group of which they are a member and, accordingly, there is a need for only limited storage size. During authentication between two devices the “prover” then presents two certificates: the latest revocation message, which shows that a group of which the prover is a member, has not been revoked, and a certificate (installed in the factory), that confirms its Device ID (i.e., that this device is a member of the group mentioned in the step regarding the latest revocation message).

Typically, such a certificate contains a Device ID i and a public key PKᵢ. An attacker having intercepted a certificate for a group of which i is a member and trying to now impersonate i, will not have the secret key SKᵢ corresponding to PKᵢ and all further communication will be aborted, in accordance with the authentication protocols mentioned before.

To describe the advantages, the following notation is introduced:
Every device has a Device ID, i, 0≦i<N, where N=2ⁿ is the total number of devices: every Device ID number is an n-bit string;
D={0,1, . . . ,N−1} is the set of all devices;
R={f₁, f₂, . . . ,fᵣ} is the set of r revoked devices (which changes/grows from generation to generation).

The certification authority transmits an (individualized) message to every one of the m groups S₁, . . . ,Sₘ, certifying that the members of that group have not been revoked. Every member of group i stores message/certificate for group i. The groups are chosen such that S₁∪S₂∪ . . . ∪Sₘ=D|R (i.e., all sets Sₖ, 1≦k≦m together form the set of non-revoked devices which equals D minus the set of revoked devices).

The question to be solved is how to choose the partition of D|R into S₁ . . . Sₘ given R. Note that this partition will be different in a next generation when R has changed. Assume that N is typically a 40-bit number (in effect allowing approx. 200 devices per person in the whole world), and r=|R|, the number of revoked devices is <100,000. Below, five such partitions are being discussed as well as their respective cost in transmission and storage size. These partitioning schemes are the Simple Black-Listing; the Simple White-Listing; the Complete Subtree Method; the Subset Difference Method; and the Modified Black-Listing Method. After discussing partitioning methods and their cost, the impact of signatures will be considered.

Simple Black-Listing

As stated above, to minimize transmission size, the best one can do is to send a signed message to all devices stating the elements of R. In effect D|R is partitioned into a single group, m=1. The theoretical lower bound on the transmission size is:
log₂(ᵣ^{N})≈r log₂ N−r log₂ r=rn−r log₂ r bits.
The approximation holds when 1<<r<<N, which is the range of parameters that is relevant for a content protection system. A trivial implementation that closely approximates this lower bound is for the authority to transmit a signed list of all the revoked devices taking r·n bits (every device has an n-bits Device ID). The storage size is obviously the same: r·n bits (˜½ Mbyte).
Simple White-Listing

In order to minimize storage size, the authority sends a separate certificate to every non-revoked device, containing its Device ID. In effect, D|R is partitioned into m=|D|R|=(N−r)-groups, each group with only member. The transmission size is (N−r)·n (or perhaps (N′−r)·n, where N′=#-devices issued to date).

Complete Subtree Method

A method for partitioning a set of identifiers into a hierarchically ordered set is described in D. Naor, M. Naor, J. Lotspiech, “Revocation and Tracing Schemes for Stateless Receivers”, Adv. in Cryptology, CRYPTO '01, LNCS 2139, Springer 2001, pp. 41-62, but this article does not discuss using the ordered set to create group identifiers like in the present invention.

To discuss the Complete Subtree Method, and the Subset Difference Method addressed further below, all the possible n-bit Device IDs are being interpreted as leaves (end-points) of an (n+1)-layer binary tree. Some terminology:
The endpoints of the tree are called the leaves. There are 2″ leaves in an (n+1)-layer tree.
A node is a place where the branches of the tree join. The leaves are also considered nodes.
The root is the top-most node.
When node v lies directly above the node u, v is called the parent of u, and u the child of v. The other child of v: u′, is called the sibling of u. v, together with its parent, grandparent etc., are called the ancestors of u, and conversely u their descendant.
The subtree rooted at v is the set consisting of v and all its descendants.

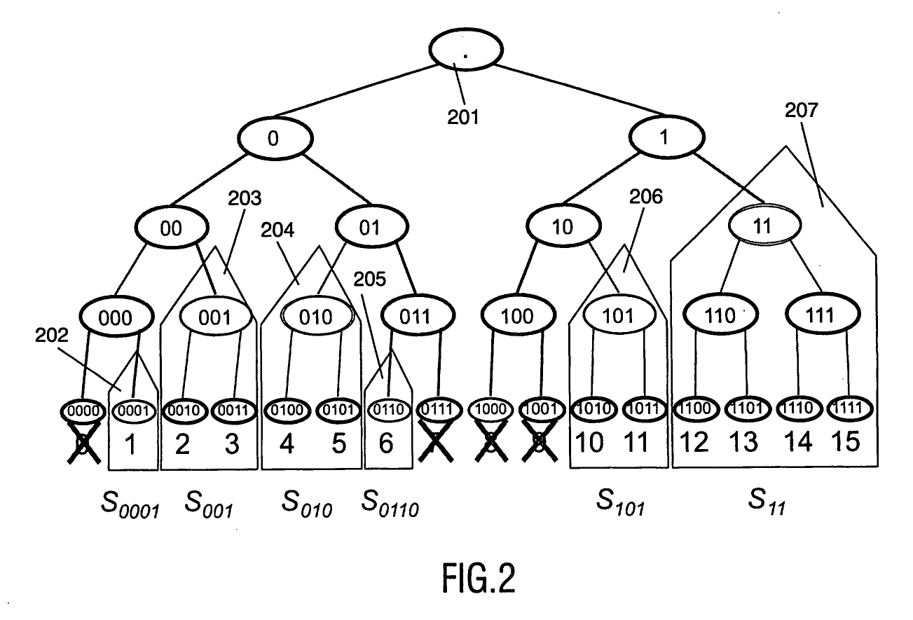

Moving up the tree (visiting ancestors) is like chopping of LSBs (Least Significant Bits) of the binary representation of a Device ID, one bit per layer. Assume a number of leaves, R={f₁, . . . , fᵣ} have been revoked. A path is now drawn from every one of the revoked leaves upwards, to the root of the tree. The collection of merging paths is called the Steiner Tree ST(R) corresponding to leaves R. This is illustrated in FIG. 2, wherein a binary tree construction is given for N=16 devices. Devices with Device ID 0, 7, 8 and 9 have been revoked. The paths through the tree connecting the revoked nodes eventually with the topmost node 201 form the corresponding Steiner Tree ST(R). These paths lie outside the enclosed areas 202-207. At the top of each enclosed area lie nodes that are the siblings hanging off the Steiner tree which generate the groups Sᵢ that are represented by the enclosed areas, which are labeled S₀₀₀₁, S₀₀₁, S₀₁₀, S₀₁₁₀, S₁₀₁, and S₁₁.

For the Complete Subtree Method concentrate on the nodes “hanging off” ST(R): i.e. the siblings of the nodes on ST(R), referred to as {v₁, . . . ,vₘ}. The certification authority now chooses the partition S₁, . . . ,Sₘ, where Sᵢ corresponds to the leaves of the subtree rooted at vᵢ. Every certificate contains only one vᵢ. By construction no elements of R can be an element of the Sᵢ and every element of D|R must be included in S₁∪S₂∪ . . . ∪Sₘ. The groups are non-overlapping.

One might think that there are about m=r·n nodes hanging off ST(R): n nodes for every revoked device (its path to the root has n nodes) and r devices. However it can be shown that m≦r·(n−log₂ r). The reason is that paths in ST(R) tend to merge long before they reach the root. Using this, and the fact that every vᵢ is an n-bit number, the transmission size of revocation message is bounded by an upper limit of n·r·(n−log₂ r) [10s of Mbytes]. As to the storage size: a device only stores the signature of the Sᵢ to which it belongs: n-bits.

If a further device has to be revoked, say the device with device ID 3 in FIG. 2, then a new group (and corresponding group certificate) S₀₀₁₀ is created which replaces S₀₀₁. This replacement could be realized by e.g. adding a higher version number to S₀₀₁₀. If group certificates bear validity period indicators, the certificate S₀₀₁₀ automatically expires after its validity period has passed, and then replacement is automatic.

If instead the device with device ID 14 were revoked, two new group certificates are necessary. The first group certificate, corresponding to the group S₁₁₀, identifies the subtree for the group S₁₁ which does not encompass the device ID 14. The second group certificate corresponds to the subtree for S₁₁₁₁.

Subset Difference Method

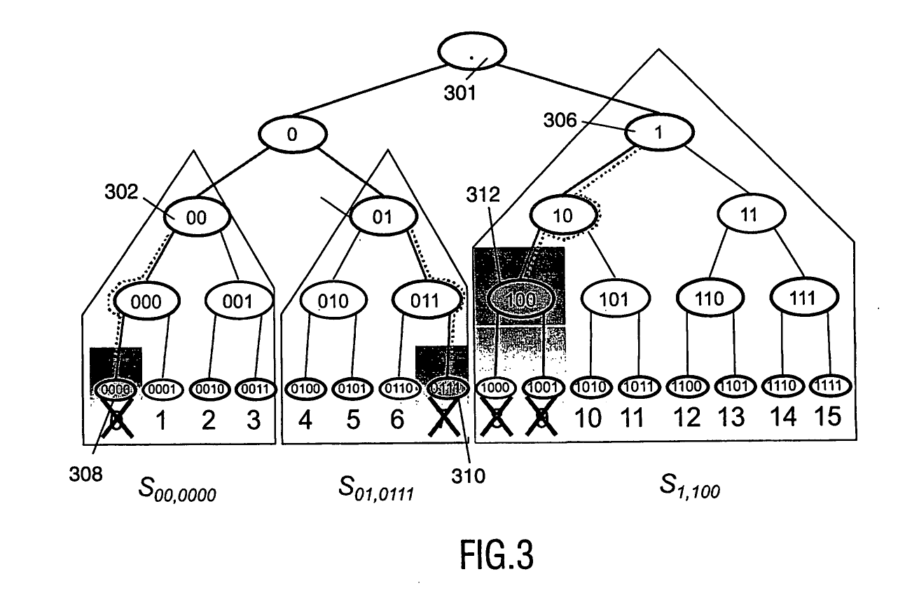

This method, illustrated in FIG. 3 for N=16 devices, interprets the Device IDs of the devices as leaves in a binary tree, similar to the Complete Subtree Method discussed above. Again, a Steiner Tree ST(R) is drawn. Now, chains of outdegree 1 are identified on ST(R): i.e., consecutive nodes of the Steiner Tree which have only a single child or sibling on ST(R): the dotted lines in FIG. 3. To every such chain a group S_{a,b} is assigned, to which to send a certificate as follows: let a be the first element of the chain (just after a node of outdegree 2), and b be the last (a leaf or node of outdegree 2). Then S_{a,b} is the set of leaves of the subtree with a as a root, minus the leaves of the subtree with b as a root.

Devices with Device ID 0, 7, 8 and 9 have been revoked. The corresponding Steiner tree is formed by nodes labeled 0000, 000, 00, 0, 01, 011, 0111, 1000, 1001, 100, 10, 1 and by top node 301. The a's are the nodes 302, 304 and 306 at the top of each enclosed area, and the b's the nodes 308, 310 and 312. S_{a,b} is the outermost enclosed area minus the area occupied by the subtrees hanging off the b-nodes 308-312.

The point is that such a chain (between the merging of two paths going from the bottom towards the top of the tree) can never have descendants which are revoked (otherwise there would be a node outdegree 2 in this chain on the Steiner Tree). Note that the groups are non-overlapping due to the fact that binary trees are used. Of course other types of trees or hierarchical orderings could be used in which overlapping could occur. This makes no difference for the present invention.

It can be shown that this construction is very efficient: at most 2r−1 groups S_{a,b} are needed to cover D|R. In fact, the worst case obscures the fact that for randomly chosen R={f₁, . . . ,fᵣ} a more realistic number of groups is 1.25·r. To determine the transmission size, one needs to compute how to encode efficiently the pair {a, b} in S_{a,b}. Note that if a is at layer j, and b at layer k, b has the first j bits in common with a.

A practical way to encode {a, b} is to transmit bit-string j∥k∥b, where “∥” denotes concatenation. Since j and k take log₂ n bits (approx. 6-bits for practical N, r), the length of j∥k∥b is bounded by upper limit (n+2·log₂ n). Thus the total transmission size is bounded by (2r−1)·(n+2·log₂ n) and more typically 1.25 r·(n+2·log₂ n) [˜1 Mbyte using typical values].

If a further device has to be revoked, say the device with device ID 3 in FIG. 3, then new groups (and corresponding group certificates) S_{001,0011} and S_{000,0000} are created which replace S_{00,0000}.

Modified Black-Listing Method

This method directly combines the small transmission size of the simple black listing method discussed above with the small storage size of the white listing methods. Basically, D|R is partitioned into m=|D|R|=(r+1) groups, where each group Sᵢ consists of the devices {fᵢ+1 . . . fᵢ₊₁−1}. In a naïve scheme this leads to a transmission size of 2·r·n. A more efficient scheme is the following: if a sorted list of all revoked devices (e.g., in ascending order) is created, then the authorized groups consist of the devices between any two elements of this list. Now the transmission size is only at most ran, which is equal to the size in the simple black listing case (of course, the data that is transmitted is identical to the black list, but the interpretation is different).

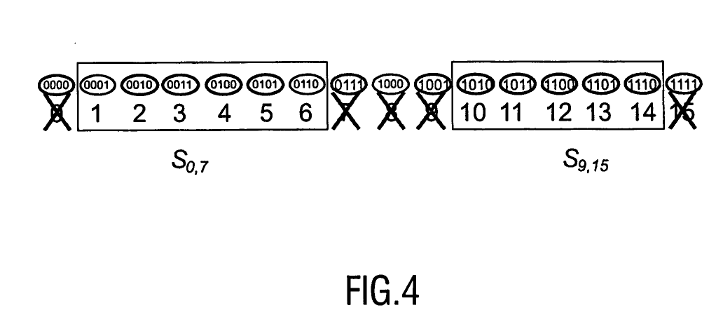

For storage, the devices only extract the certificate that contains the Device IDs of the two revoked devices that bracket its own Device ID. E.g., in FIG. 4 device 4 would only store the certificate covering the group S_{0,7}: about 2n bits of information.

The notation of the boundaries of the ordered list can of course be chosen in a variety of ways. In the above example, the numbers 0 and 7 represent two revoked devices, and the non-revoked list comprises the numbers 1 through 6 inclusive. One could just as well refer to the group S_{0,7} as S_{1,6}. This is a mere matter of convention and ease of notation.

Efficient Certificate Distribution

The sections above outline how to provide in an efficient manner (with regard to both transmission- and storage-size) revocation/authorization information to devices by dividing the devices into groups and distributing certificates for groups. Below some examples are discussed as to how to turn group-identifiers (group IDs), such as the a,b in S_{a,b}, into certificates: i.e., how to apply the Certification Authority's signature to such group-identifiers. As described above signatures expand a message by C-bits, typically 1024 bits, independent of the message-size itself. So naively, if certificates are transmitted to m groups, where each group-identifier is l-bits, the total transmission size is not m·l-bits, but m·(l+C) bits. Because for the methods outlined above l is typically only in the order of 40 . . . 100-bits, i.e., l<<C, the signatures constitute the bulk of the transmission-/storage-size. However, because C is independent of the message-size that the signature protects, the inventors propose the following optimizations to drastically reduce the overhead due to the signature.

In a first optimization scheme, the certificate is constructed with a message-part containing the group-IDs for multiple groups, to which a signature over all of these group-IDs is added. The certificate validates, as it were, a group-of-groups. Note: for practical reasons, the total length of the group-IDs in a group-of-groups preferably does not exceed C.

In a further optimization scheme, the message part of the certificate is compressed. Signatures of messages with length m<C can have the property that the message can be retrieved from just the signature itself! Naively one might think that it is no longer necessary to include the group-IDs themselves into the message-part of the certificate. However, filtering certificates, i.e., deciding which certificate must go to which device, e.g. by a gateway device, becomes then very difficult/costly, because signature processing is very expensive and would have to be done for every certificate.

To help such a filtering device the following is proposed: if it is possible to define an ordering amongst the group-IDs, such as in the case of Simple-White-Listing, Complete Subtree Method or Modified Black-Listing, the message part of the certificate only needs to contain the “lowest” and “highest” group-IDs present in the group-of-groups (where “lowest” and “highest” are determined relative to the ordering relation). This allows the filter to decide whether this certificate might contain a relevant group-ID. This can then be verified by the destination device itself inspecting the signature. It allows the rapid rejection of the bulk of certificates that are irrelevant.

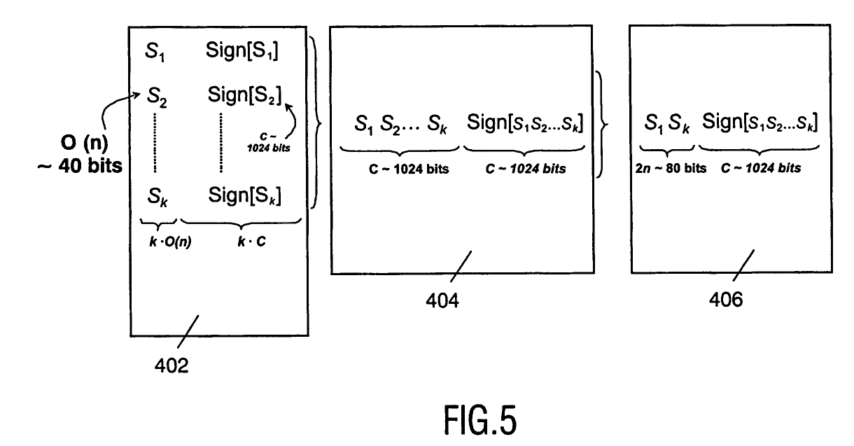

The above is illustrated in the tables of FIG. 5. Reference numeral 402 indicates the scheme wherein each respective group of a set of k groups S₁, . . . , Sₖ is provided with a respective signature Sign[S₁], . . . , Sign[Sₖ]. Each group Sᵢ is identified by a string with a length on the order of typically 40 bits, as mentioned earlier. The length of the signature Sign[Sᵢ] is typically 1024 bits as mentioned above.

Reference numeral 404 indicates the scheme of the first optimization mentioned above. The number of signatures, here: k, is now replaced by a single signature that validates the whole group S₁, . . . , Sₖ. If there are more than k signatures, more certificates (each for every group of k certificates) would need to be created. However, it will be clear that this still results in a substantial saving in the number of certificates that need to be distributed: one for every k original certificates.

Reference numeral 406 relates to the further optimization explained above that comprises reducing the message S₁S₂ . . . Sₖ to S₁Sₖ. This further optimization reduces the factor of two of the first scheme to a factor of the order of (1024+80)/1024≅1.08. That is, the overhead from the signatures is cancelled almost completely.

These optimizations affect the various partitioning schemes, discussed earlier, as follows.

Simple Black-Listing

In this case the certificate gets appended to the long blacklist of r·n bits, which yields a total of r·n+C bits transmission size. The same holds for storage. The signature size is negligible. Optimizations with respect to signature application do not work because there is only one group.

Simple White-Listing

There are (N−r) groups in total of size (roughly) n-bits each. Appending a signature yields (N−r)·(C+n) bits in transmission size. With the first optimization scheme, only a single signature needs to be computed/transmitted for every └C/n┘ non-revoked devices (because └C/n┘ serial-numbers take └C/n┘·n≈C bits). To apply the further optimization, the (non-revoked) devices are ordered, e.g., by Device ID, and only the first and the last in such a group of └C/n┘ serial-numbers are put in the message-part itself. This results in a transmission size of ((N−r)/└C/n┘)·(2n+C)≈N·(n+2n²/C)≈N·n. (Here N is the total number of issued devices). For storage obviously only one certificate needs to be retrieved and stored: C bits.

Complete Subtree Method

There are r·(n−log₂ r) groups, each described by an n-bit number (tree-node). Following the first optimization, └C/n┘ of those can be fit into C-bits, and a single signature can be supplied for them together. The further optimization can also be performed by ordering the tree-nodes, and then leaving only two (lowest and highest) tree-nodes in the message itself. The total transmission size is (r·(n−log₂ r)/└C/n┘)·(2n+C)≈r·(n−log₂ r)·(n+2n(n+1)/C)≈nr·(n−log₂ r). For storage, only a single certificate needs to be stored: C bits.

Subset Difference Method

There are (statistically) 1.25 r groups, each described by an (n+2·log₂ n)-bit number (2 tree-nodes). Following the first optimization, └C/(n+2·log₂ n)┘ of those can be accommodated in C-bits and a single signature can be supplied for all of them together. The further optimization can also be performed by means of ordering the tree-nodes, leaving only two tree-nodes in the message itself. The total transmission size is then (1.25r/└C/(n+2·log₂ n)┘)·(2n+C)≈1.25r·(n+2log₂ n). For storage, only the signature part of a single certificate needs to be stored, the message itself is not necessary: C-bits.

Modified Black-Listing Method

There are (r+1) groups described by r numbers of n-bits each. Following the first optimization, └C/n┘ numbers can be accommodated in C-bits and a single signature can be provided for all of them together. The further optimization can also be performed: say a signature protects the group-of-groups described by {f₁, f₂ . . . fₖ}, i.e., the groups S(f₁,f₂) S(f₂,f₃) . . . S(fₖ₋₂,fₖ₋₁) S(fₖ₋₁,fₖ). Such a group-of groups can described by just putting f₁ and fₖ in the message part. The transmission size then comes to ((r+1)/└C/n┘)·(C+2n)≈r·n. For storage, only the signature part of a single signature needs to be stored, the message itself is not necessary: C-bits.

Note that for random distribution of revoked devices, the Modified Black-Listing method is superior by far to any of the other methods. In fact, it almost achieves the lower bound in transmission size given by black-listing and the lower bound in storage size given by white listing. The other methods may become relevant if devices are organized hierarchically, e.g., if typically all devices of a certain model need to be revoked.

The invention thus provides several methods to reduce the overhead due to signatures by not transmitting most of the message-part of the certificate, and reconstructing it upon reception from the signature-part. From a cryptographic point this may introduce a security risk, because efficiently packed signatures, with a message having little redundancy, and signatures without significant redundancy are considered unsafe: they are too easy to create without the private key of the Certification Authority. A hacker would just generate a random C-bit number and present it as a certificate. If almost all messages are considered valid, also all signatures will be considered valid! Below it is discussed why there is still enough redundancy left in the description of groups-of-groups so that it is effectively impossible for a hacker to construct invalid signatures.

Verification of a certificate's signature requires prior knowledge of its internal format, in addition to the Certificate Authority's public key. A commonly used technique is to calculate a hash value over the entire message, and include that in the data that is covered by the signature (i.e. encrypted using the Certificate Authority's private key). This technique has the drawback that it extends the size of the message by at least the size of the hash value—except in cases where the message is sufficiently short. Note that this data covered by the signature may include part of the original message, where that part is not transmitted otherwise, which case is referred to as digital signatures with message recovery. Alternatively, the entire message may be transmitted separately from the signature, which case is being referred to as digital signatures with appendix.

For several of the methods described here an alternative technique can be used that is more efficient with respect to certificate size. As explained before, two certificates are being used to vouch for a device's authorization. The first is a so-called Device Certificate, which contains a device's ID and its public key. It is built into a device at manufacturing time. The second is a so-called Authorization Certificate, which contains a list of some device IDs that are authorized. Only devices that are able to present a Device Certificate with an ED that is listed in a corresponding Authorization Certificate will be authenticated by the system. This relation between the two certificates is one of the ingredients that will be used in the signature verification process. The other ingredient is knowledge of the encoding format of the authorized device IDs in the Authorization Certificates. Note that only verification is considered of an Authorization Certificate's signature. Verification of a Device Certificate's signature can be performed according to standard techniques, e.g., those using a hash function.

In the following it is assumed that the list of authorized device IDs is partitioned into a set of groups, which are characterized by n bit numbers. It is also assumed that the size of a signature, i.e. an Authorization Certificate, is C bits. The total number of groups that can be represented is N=2ⁿ. Finally, in order to (slightly) reduce the encoding complexity, it is assumed that devices 0 and N−1 are revoked from the start.

A number of k=└(C−m)/n┘ group IDs are packed per certificate, with m representing a number of bits to encode the sequence number of the certificate and other relevant information. The boundary condition for a valid certificate is that all group IDs are unique, and sorted in ascending order, e.g., ID₀<ID₁< . . . <IDₖ₋₁. Now, if a certificate contained fewer than k group IDs, the open places would be filled with random data that conforms to this boundary condition. Part of the reserved bits represented by m would then be used to indicate the number of valid entries. Generating a random signature corresponds to signing a random sequence of k group IDs. The probability P that the boundary condition is satisfied (i.e., they are ordered) equals:
P=[N.(N−1) . . . (N−k+1)]/N^{k}k!≈{1−[(k−1).k]/2N}/k!≈1/k!
For realistic values of C and n, e.g., n=40 and C=1024, this probability Pₗᵢₛₜ≅1/2⁸³. The meaning of this number is that an attacker would have to perform in between 2⁸² and 2^{81+m} public key operations in order to generate a valid Authorization Certificate. This number is prohibitively large for an attacker to successfully generate false certificates.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of controlling authentication of a first device to a second device, the devices being assigned respective device identifiers, the method comprising distributing to the first device a group certificate identifying a range of non-revoked device identifiers, said range encompassing the device identifier of the first device.

2. The method of claim 1, in which the respective device identifiers correspond to leaf nodes in a hierarchically ordered tree, the method further comprising identifying in the group certificate a node in the hierarchically ordered tree, said node representing a subtree in which the leaf nodes correspond to the range of non-revoked device identifiers.

3. The method of claim 2, further comprising identifying in the group certificate a further node in the subtree, said further node representing a further subtree in which the leaf nodes correspond to device identifiers excluded from the range of non-revoked device identifiers.

4. The method of claim 1, in which the respective device identifiers are selected from a sequentially ordered range, the method further comprising identifying in the group certificate a subrange of the sequentially ordered range, said subrange encompassing the range of non-revoked device identifiers.

5. The method of claim 1, further comprising identifying plural respective ranges of non-revoked device identifiers in a single group certificate.

6. The method of claim 5, in which the plural respective ranges in the single group certificate are sequentially ordered, the method further comprising identifying the plural respective ranges in the single group certificate through an indication of the lowest and highest respective ranges in the sequential ordering.

7. The method of claim 1, in which the group certificate comprises an indication of a validity period.

8. The method of claim 1, in which the group certificate comprises a version indication.
